(19) United States
(12) Patent Application Publication
(10) Pub. No.: US 2011/0072812 A1
(43) Pub. Date: Mar. 31, 2011

(54) BRAKE FOR VEHICLE

(76) Inventor: Young Jun SON, Gyeonggi-do (KR)

(21) Appl. No.: 12/890,098

(22) Filed: Sep. 24, 2010

(30) Foreign Application Priority Data
Sep. 25, 2009 (KR) 10-2009-0091178

(51) Int. Cl. B60T 17/00

(52) U.S. Cl. 60/565

(57) ABSTRACT

Disclosed is a brake for a vehicle, capable of preventing a vacuum connection pipe connected to a brake booster from being rotated. The brake includes a brake booster generating boosting force and including a casing, a vacuum connection pipe coupled with the casing, a master cylinder body connected to the brake booster, and an oil tank communicated with the master cylinder body. The oil tank includes an anti-rotation member extending from one side of the oil tank toward the vacuum connection pipe to prevent the vacuum connection pipe from being rotated.

This application claims the benefit of Korean Patent Application No. 10-2009-0091178 filed on Sep. 25, 2009, in the Korean Intellectual Property Office, the disclosure of which is incorporated herein by reference.

### BACKGROUND OF THE INVENTION

1. Field of the invention

The present invention relates to a brake for a vehicle. More particularly, the present invention relates to a brake for a vehicle, capable of preventing a vacuum connection pipe connected to a brake booster from being rotated.

2. Description of the Related Art

In general, a brake for a vehicle includes a brake booster generating boosting force and a master cylinder generating liquid pressure.

The brake booster generates great braking force based on small force by using pressure difference between vacuum pressure and atmospheric pressure and transfers the braking force to the master cylinder to generate braking hydraulic pressure.

The brake booster having the above function includes a casing having a front shell and a rear shell, an input shaft interworking with a brake pedal, and an output shaft receiving power that may vary depending on the operation of the input shaft.

The casing is divided into a static pressure chamber and a variable pressure chamber by a diaphragm and a power piston. A vacuum connection pipe is coupled to one side of an outer wall of the static pressure chamber to allow the static pressure chamber to communicate with an engine suction part.

In addition, a valve body is coupled to the casing to control the amount of air introduced into the brake booster. One end of the valve body is fixed to the diaphragm and the power piston and the other end of the valve body is formed with an air suction hole and protrudes outward from a rear end of the casing to communicate with the outside while interworking with the reciprocating movement of the input shaft.

In the initial state of the brake booster for the vehicle having the above structure, the static pressure chamber and the variable pressure chamber are maintained in the vacuum state by the engine suction part. When a driver steps on a brake pedal, the input shaft moves forward so that external air is introduced into the variable pressure chamber through the valve body. At this time, the external air is instantly introduced into the variable pressure chamber due to differential pressure, so the diaphragm and the power piston are pushed toward the static pressure chamber. Thus, amplified output force is transferred to the master cylinder assembly through the output shaft, thereby generating the braking hydraulic force.

If the driver puts the foot off the brake pedal, the input shaft returns to its initial position by a return spring and elastic restoring force of the power piston. In addition, air in the variable pressure chamber is introduced into the static pressure chamber under the vacuum state through a static pressure path, and air in the static pressure chamber is discharged through the vacuum connection pipe and a vacuum hose, so that the static pressure chamber is maintained in the vacuum state. Thus, the brake booster returns to the initial state.

The static pressure chamber must be constantly maintained under the vacuum state to allow the brake booster to perform its function. In this regard, the vacuum connection pipe connected to the vacuum hose is provide in the casing in such a manner that air contained in the static pressure chamber can be discharged by suction force of an engine.

In detail, one end of the vacuum connection pipe is connected to the casing of the brake booster and the other end of the vacuum connection pipe is connected to an end of the vacuum hose so that the static pressure chamber is communicated with the vacuum hose.

The vacuum connection pipe connected to the casing of the brake booster is made from metallic material or plastic material. If the vacuum connection pipe is made from the metallic material, the vacuum connection pipe is coupled to the casing through welding. In addition, if the vacuum connection pipe is made from the plastic material, the vacuum connection pipe is assembled with the casing.

However, in the case that the vacuum connection pipe made from the plastic material is assembled with the casing, the vacuum connection pipe may be tilted from the precise position due to the weight of the vacuum hose and vibration of the vehicle, so that the vacuum connection pipe may interfere with other components.

### SUMMARY OF THE INVENTION

According to one aspect of the present invention, there is provided a brake for a vehicle, capable of improving reliability by preventing a vacuum connection pipe connected to a brake booster from being rotated.

Additional aspects and/or advantages of the invention will be set forth in part in the description which follows and, in part, will be apparent from the description, or may be learned by practice of the invention.

The foregoing and/or other aspects of the present invention are achieved by providing a brake for a vehicle, the brake comprising: a brake booster generating boosting force and including a casing; a vacuum connection pipe coupled with the casing; a master cylinder body connected to the brake booster; and an oil tank communicated with the master cylinder body, wherein the oil tank includes an anti-rotation member extending from one side of the oil tank toward the vacuum connection pipe to prevent the vacuum connection pipe from being rotated.

The anti-rotation member is integrally formed with the oil tank.

The anti-rotation member is provided at an end thereof with a ring member surrounding an outer peripheral surface of the vacuum connection pipe.

The ring member is fitted around the outer peripheral surface of the vacuum connection pipe.

As described above, according to the brake for the vehicle of the present invention, an anti-rotation member is installed to the oil tank, so that the vacuum pipe can is be fixedly maintained in the precise position even if external force or vibration derived from the operation of the engine is applied to the vacuum connection pipe after the vacuum connection pipe has been assembled, thereby preventing the vacuum connection pipe from interfering with other components.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view showing the schematic structure of a brake for a vehicle according to one embodiment of the present invention; and

FIG. 2 is a side sectional view of FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements. The embodiments are described below to explain the present invention by referring to the figures.

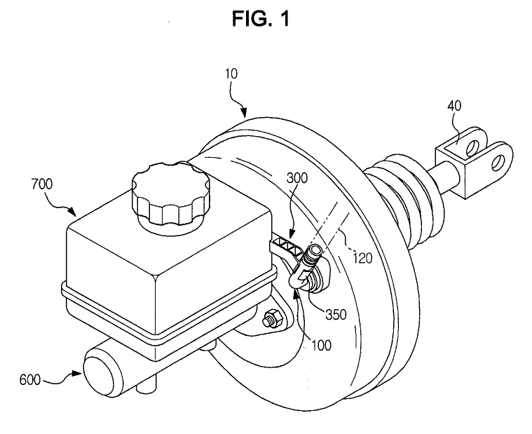

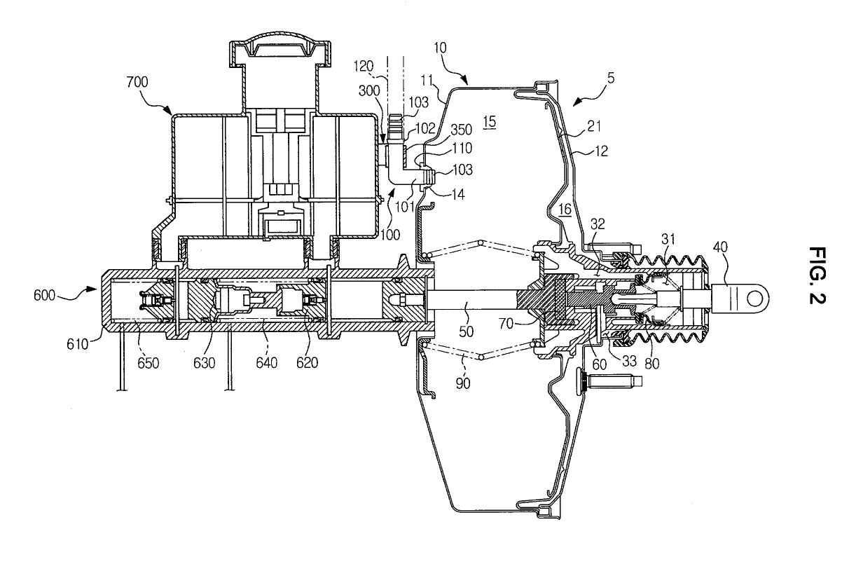

FIG. 1 is a perspective view showing the schematic structure of a brake for a vehicle according to one embodiment of the present invention, and FIG. 2 is a side sectional view of FIG. 1.

As shown in FIGS. 1 and 2, the brake for the vehicle according to one embodiment of the present invention includes a brake booster 5 generating boosting force and a master cylinder 600 generating liquid pressure.

The brake booster 5 includes a casing 10 having a front shell 11 and a rear shell 12 closely coupled with each other, a diaphragm 20 dividing the interior of the casing 10 into a static pressure chamber 15 and a variable pressure chamber 16, a power piston 21 adjacent to the diaphragm 20 to receive power generated due to pressure difference between the static pressure chamber 15 and the variable pressure chamber 16, a valve body 30 having one end slidably passing through the center of the diaphragm 20 and the other end protruding to the outside through the center opening of the rear shell 12 to control air introduced into the brake booster 5, an input shaft 40 interworking with a brake pedal (not shown), and an output shaft 50 receiving power that may vary depending on the operation of the input shaft 40.

The valve body 30 has a cylindrical shape with multi-step configuration. The diaphragm 20 and the power piston 21 are coupled to an outer peripheral portion of one end of the valve body 30, and the outer end of the valve body 30 is formed with an air suction part 31 and extends to the outside through the center of the rear shell to communicate with the atmosphere.

The valve body 30 is formed therein with a static pressure path 32 extending through the static pressure chamber 15 and the variable pressure chamber 16, and a variable pressure path 33 through which the variable pressure chamber 16 is communicated with the atmosphere. In addition, a plunger 60 is provided in the valve body 30. The plunger 60 is coupled with the end of the input shaft 40 to slidably move in the axial direction. A reaction disc 70 is provided between the output shaft 50 and the front end of the plunger 60 in order to transfer force to the output shaft 50 by boosting the force based on the difference in sectional area. In addition, a poppet valve 80 made from elastic material is provided in the valve body 30. The poppet valve 80 selectively open/close the static pressure path 32 and the variable pressure path 33 in order to control air introduced into the valve body 30 according to the operation of the input shaft 40.

A vacuum connection pipe 100 is coupled to an outer wall of the front shell 11 to allow the static pressure chamber 15 to communicate with an engine suction part (not shown), and a return spring 80 is installed in the static pressure chamber 15 to return the diaphragm 20, the power piston 21 and the valve body 30 to their initial positions.

The vacuum connection pipe 100 is made from plastic material and has the right-angled elbow structure. One end 101 of the vacuum connection pipe 100 is communicated with the static pressure chamber 15 and the other end 102 of the vacuum connection pipe 100 is coupled with an end of the vacuum hose 120 connected to the engine suction part.

A coupling hole 14 is formed in the front shell 11 of the casing 10 that constitutes the static pressure chamber 15, and a sealing member 110 made from elastic material is coupled into the coupling hole 14.

One end 101 of the vacuum connection pipe 100 is press-fitted into a hollow part of the sealing member 110 and communicated with the static pressure chamber 15, and the vacuum hose 120 is connected to the other end 102 of the vacuum connection pipe 100. Anti-separation protrusions 103 are formed at both ends 101 and 102 the vacuum connection pipe 100, so the vacuum connection pipe 100 is not separated from the sealing member 110 and the vacuum hose 120.

A master cylinder 600, which is connected to the output shaft 50, is coupled with the front shell 11. The master cylinder 600 includes a body 610 coupled with the front shell 11, a first piston 620 accommodated in the body 610 and connected to the output shaft 50, and a second piston 630 interworking with the first piston 620. In detail, as the output shaft 50 moves forward, the first and second pistons 620 and 630 move forward so that oil supplied from an oil tank 700 communicated with the body 610 is transferred to front and rear wheels. A first spring 640 is elastically installed between the first and second pistons 620 and 630, and a second spring 650 is elastically installed between the body 610 and the second piston 630. The first and second springs 640 and 650 return the first and second pistons 620 and 630 to their initial positions when external force applied to the brake pedal has been removed.

The oil tank 700 is provided at one side thereof with an anti-rotation member 300 for preventing the vacuum connection pipe 100 from being rotated.

The anti-rotation member 300 extends to the vacuum connection pipe 100 from one side of the oil tank 700 and is integrally formed with the oil tank 700 when the oil tank 700 is manufactured.

The anti-rotation member 300 is provided at an end thereof with a ring member 350 made from elastic material such that the vacuum connection pipe 100 can be inserted into the ring member 350. In addition, when the brake for the vehicle is assembled, the vacuum connection pipe 100 is inserted into the ring member 350 of the anti-rotation member 300, so that the vacuum connection pipe 100 can be precisely fixed.

Hereinafter, the operation and effect of the brake for the vehicle according to the present invention will be described.

If the driver steps on the brake pedal while driving the vehicle, the input shaft 40 moves forward so that external air is introduced into the variable pressure chamber 16 under the vacuum state through the variable pressure path 33. At this time, the diaphragm 20 and the power piston 21 are pushed toward the static pressure chamber 15 due to the differential pressure and the output shaft 50 moves the first and second pistons 620 and 630 of the master cylinder 600 in the forward direction by applying amplified force to the first and second pistons 620 and 630 of the master cylinder 600, thereby generating the braking hydraulic pressure.

In addition, if the driver puts the foot off the brake pedal, air in the variable pressure chamber 16 is discharged to the static pressure chamber 15 under the vacuum state through the static pressure path 32. Since the engine suction part is always driven, the air in the static pressure chamber 15 is discharged through the vacuum connection pipe 100 and the vacuum hose 120 so that the static pressure chamber 15 is maintained in the vacuum state. Thus, the brake booster 5 returns to the initial state.

In this case, the vacuum connection pipe 100 is subject to the rotation due to the weight of the vacuum hose 120 and vibration generated during the operation of the engine. However, since the vacuum connection pipe 100 is fitted into the ring member 350 of the anti-rotation member 300, the vacuum connection pipe 100 can be fixedly secured without rotating.

Therefore, the vacuum connection pipe 100 can be prevented from interfering with other components.

Although few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A brake for a vehicle, the brake comprising:
a brake booster generating boosting force and including a casing;
a vacuum connection pipe coupled with the casing;
a master cylinder body connected to the brake booster; and
an oil tank communicated with the master cylinder body,
wherein the oil tank includes an anti-rotation member extending from one side of the oil tank toward the vacuum connection pipe to prevent the vacuum connection pipe from being rotated.

2. The brake as claimed in claim 1, wherein the anti-rotation member is integrally formed with the oil tank.

3. The brake as claimed in claim 1, wherein the anti-rotation member is provided at an end thereof with a ring member surrounding an outer peripheral surface of the vacuum connection pipe.

4. The brake as claimed in claim 3, wherein the ring member is fitted around the vacuum connection pipe.
